(19) United States
(12) Patent Application Publication
(10) Pub. No.: US 2022/0006385 A1
(43) Pub. Date: Jan. 6, 2022

(54) LOAD DRIVING DEVICE

(71) Applicant: HITACHI ASTEMO, LTD., Hitachinaka-shi, Ibaraki (JP)

(72) Inventor: Nobuyuki KUROIWA, Hitachinaka-shi, Ibaraki (JP)

(73) Assignee: HITACHI ASTEMO, LTD., Hitachinaka-shi, Ibaraki (JP)

(21) Appl. No.: 17/283,319

(22) PCT Filed: Nov. 1, 2019
(86) PCT No.: PCT/JP2019/043020

§ 371 Date: Apr. 7, 2021

(30) Foreign Application Priority Data
Nov. 2, 2018 (JP) 2018-207321

(51) Int. Cl. H02M 3/335

(52) U.S. Cl. CPC H02M 3/33507; B60G 17/015

(57) ABSTRACT

A load driving device includes a flyback converter, the flyback converter including: a transformer including a primary coil to be connected to a power supply and a secondary coil to be connected to a load; and a switching element provided on a ground side of the primary coil, which controls a voltage to be applied to the primary coil. The load driving device is configured to generate a comparison voltage (V_{c}) which is lower than a voltage (V_{ds}) between the primary coil and the switching element, and to change a drive signal (V_{g}s) for the switching element to switch the switching element from an OFF state to an ON state when (time t_{c}) the comparison voltage (V_{c}) is reduced to a predetermined voltage (ground potential).

### CROSS-REFERENCE TO RELATED APPLICATIONS

The present application is a 371 of PCT/JP2019/043020, filed Nov. 1, 2019, which is based upon and claims priority to Japanese Patent Application No. 2018-207321, filed on Nov. 2, 2018, both of which are incorporated herein by reference in their entireties.

### TECHNICAL FIELD

The present invention relates to a load driving device including a flyback converter.

### BACKGROUND ART

In flyback converters, the following is known: during the operation in a discontinuous current mode, when a primary-side switching element is in an OFF period, and a secondary-side rectifying diode has zero current, resonance is induced by excitation inductance of a transformer and parasitic capacitance of a switching element, for example. Assuming that such a flyback converter is an externally excited type with a constant switching frequency, when the switching element is turned on at a relatively high drain-source voltage under the resonance condition, a considerably large switching loss occurs. As a solution to reducing the switching loss under the resonance condition, the configuration as disclosed in Patent Document 1, for example, is known, in which a switching element is turned on at a timing when the drain-source voltage reaches a minimum value.

### REFERENCE DOCUMENT LIST

### Patent Document

Patent Document 1: JP H10-178776 A

### SUMMARY OF THE INVENTION

### Problem to be Solved by the Invention

However, when the switching element is turned on at the timing when the drain-source voltage reaches a minimum value, the drain-source voltage can be already lower than an input voltage, and energy accumulated in the transformer can be released and accordingly reduced. This leads to deterioration of a boosting characteristic.

In contrast, from the viewpoint of improving the boosting characteristic, it is preferred to turn on the switching element at the timing when the secondary-side rectifying diode has zero current. However, at this timing, the drain-source voltage can be higher than the input voltage. As a result, through the turning-on, a large current may flow into the switching element to cause excessive temperature rise due to a switching loss.

The present invention has been made in view of the above problem, and it is accordingly an object of the present invention to provide a load driving device capable of turning on a switching element at an appropriate timing in consideration of a balance between boosting and switching loss characteristics of a flyback converter.

### Means for Solving the Problem

In order to achieve the object, the present invention provides a load driving device including a flyback converter, the flyback converter including: a transformer including a primary coil to be connected to a power supply and a secondary coil to be connected to a load; and a switching element provided on a ground side of the primary coil, which controls a voltage to be applied to the primary coil, the load driving device being configured to generate a comparison voltage which is lower than a voltage between the primary coil and the switching element, and to switch the switching element from an OFF state to an ON state when the comparison voltage is reduced to a predetermined voltage.

### Effects of the Invention

According to the load driving device of the present invention, it is possible to turn on the switching element at an appropriate timing in consideration of the boosting and switching loss characteristics of the flyback converter.

### BRIEF DESCRIPTION OF THE DRAWINGS

FIG. 1 is a schematic diagram showing a configuration example of a vehicle damper system according to Embodiment 1 of the present invention.

FIG. 2 is a schematic sectional view showing an example of a variable-damping-force damper according to Embodiment 1.

FIG. 3 is a circuit diagram showing an example of a high-voltage supply device according to Embodiment 1.

FIGS. 4A-4D are operating waveform charts of a flyback converter according to Embodiment 1.

FIG. 5 is a graph showing how to set an amount of voltage drop in level shifting according to Embodiment 1.

FIG. 6 is a circuit diagram showing an example of a high-voltage supply device according to Embodiment 2 of the present invention.

FIGS. 7A-7C are operating waveform charts of a conventional flyback converter.

### MODE FOR CARRYING OUT THE INVENTION

Hereinafter, embodiments of the present invention will be described in detail with reference to the accompanying drawings.

### Embodiment 1

A load driving device according to Embodiment 1 of the present invention is described.

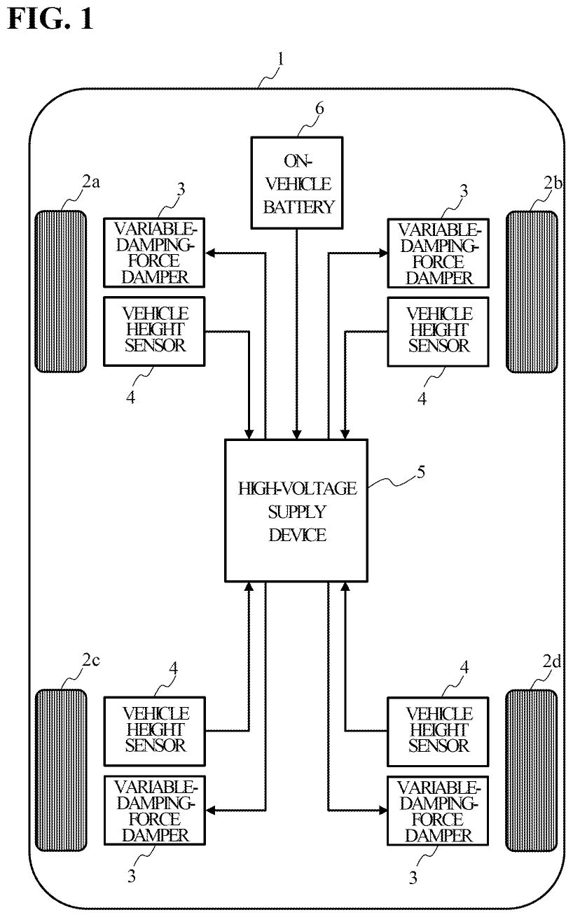

FIG. 1 shows a vehicle damper system as an application example of the load driving device. The vehicle damper system includes a variable-damping-force damper 3. Variable-damping-force damper 3 is provided to each of wheels 2a to 2d so as to damp vibrations generated by a four-wheel vehicle 1 running on an uneven road surface, for example. The inside of variable-damping-force damper 3 is filled with electrorheological fluid as working fluid. The viscosity of the electrorheological fluid changes depending on a voltage applied to variable-damping-force damper 3 (voltage as high as several kV at maximum, for example, 5 kV). In addition, through external control on the voltage to be applied thereto, the level of a damping force of variable-damping-force damper 3 can be adjusted. Variable-damping-force damper 3 constitutes a suspension device together with a suspension spring (not shown) at each of wheels 2a to 2d.

The vehicle damper system further includes a vehicle height sensor 4. Vehicle height sensor 4 is attached to the suspension device of each of wheels 2a to 2d so as to detect the vehicle height at each of wheels 2a to 2d as an example of vehicle behavior information of vehicle 1. Vehicle height sensor 4 measures the amount corresponding to the vehicle body height from the road surface at each of wheels 2a to 2d, such as vertical displacement between the vehicle body and a suspension arm. Then, vehicle height sensor 4 outputs the measured amount as a vehicle height signal.

The vehicle damper system further includes a high-voltage supply device 5. High-voltage supply device 5 supplies a voltage to be applied to variable-damping-force damper 3 so as to generate the damping force required of variable-damping-force damper 3 based on the vehicle height signal input from vehicle height sensor 4. High-voltage supply device 5 includes a flyback converter as described later. This flyback converter boosts input voltage from an on-vehicle battery 6 as a DC power supply, to supply a voltage to be applied to variable-damping-force damper 3. In short, high-voltage supply device 5 functions as a load driving device for driving variable-damping-force damper 3 as a load.

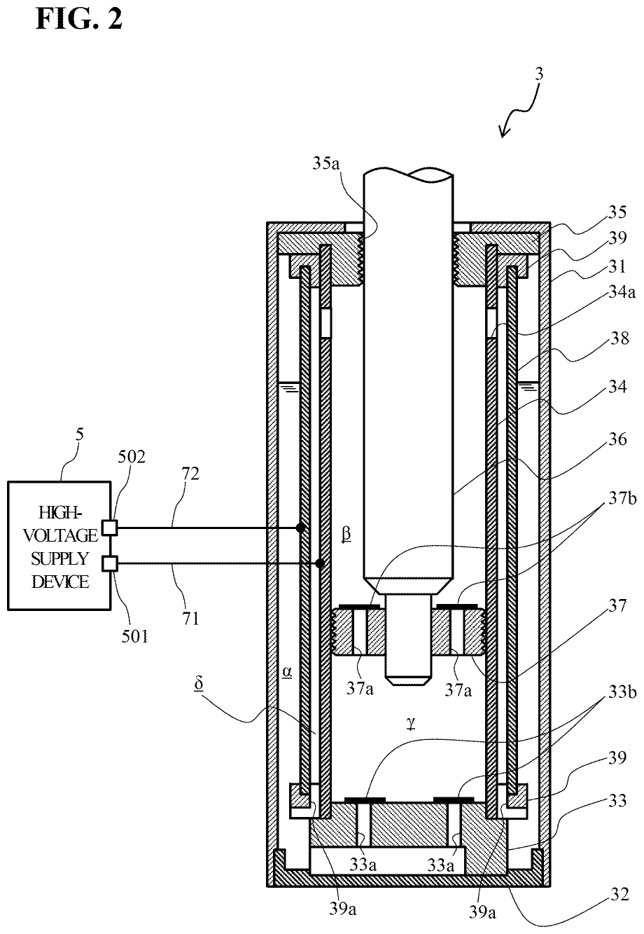

FIG. 2 schematically shows an example of the variable-damping-force damper. Variable-damping-force damper 3 has a bottomed cylindrical member obtained by closing a lower-end opening of a cylindrical outer cylinder 31 that defines the outline of variable-damping-force damper 3, by using a lower-end cap 32. In the bottomed cylindrical member, a cylindrical inner cylinder 34 with a smaller diameter than outer cylinder 31, which has a lower-end opening closed by a valve 33, is accommodated substantially coaxially with outer cylinder 31. Outer cylinder 31 and inner cylinder 34 have upper-end openings closed by an upper-end cap 35. The space between outer cylinder 31 and inner cylinder 34 (in fact, an electrode tube that will be described later) in a radial direction forms a reservoir chamber α. Inner cylinder 34 is electrically connected to an output terminal 501 of high-voltage supply device 5 via a conductive wire 71. Conductive wire 71 is electrically insulated from peripheral components except at a connection portion with inner cylinder 34 and a connection portion with high-voltage supply device 5.

In variable-damping-force damper 3, a piston rod 36 is inserted into inner cylinder 34 through an insertion opening 35a of upper-end cap 35. The space between piston rod 36 and insertion opening 35a is sealed so as to be liquid-tight and air-tight. Piston rod 36 has a piston 37 at its leading end. Piston 37 repeatedly moves vertically while sliding on an inner peripheral surface of inner cylinder 34. The inner space of inner cylinder 34 is partitioned by piston 37 into an upper cylinder chamber β on upper-end cap 35 side and a lower cylinder chamber α on valve 33 side.

The side surface of inner cylinder 34 has, near upper-end cap 35, a communication hole 34a that communicates the inside and outside of inner cylinder 34. Valve 33 has a valve communication hole 33a that communicates reservoir chamber a and lower cylinder chamber γ. Valve 33 also has provided thereon a check valve 33b for limiting flow of the working fluid into reservoir chamber α from lower cylinder chamber γ. Piston 37 has a communication hole 37a that communicates upper cylinder chamber β and lower cylinder chamber γ. Piston 37 also has provided thereon a check valve 37b for limiting flow of the working fluid into lower cylinder chamber γ from upper cylinder chamber β.

Variable-damping-force damper 3 further includes a cylindrical electrode tube 38 as a conductor. Cylindrical electrode tube 38 lies between inner cylinder 34 and outer cylinder 31, and also between upper-end cap 35 and valve 33, in the form of being substantially coaxial with, and radially spaced from, inner cylinder 34 and outer cylinder 31. Electrode tube 38 is electrically connected to an output terminal 502 of high-voltage supply device 5 via a conductive wire 72. Conductive wire 72 is electrically insulated from peripheral components except at a connection portion with electrode tube 38 and a connection portion with high-voltage supply device 5. An annular isolator 39 as an electrically insulating material, closes the radial space between inner cylinder 34 and electrode tube 38 at each of the upper end and lower end of electrode tube 38. Isolator 39 electrically isolates electrode tube 38 from outer cylinder 31 and inner cylinder 34, and other peripheral components.

The radial space between electrode tube 38 and inner cylinder 34 forms a voltage application path δ for applying a voltage to circulating working fluid. Isolator 39 at the lower end of electrode tube 38 has a communication hole 39a that communicates voltage application path δ and reservoir chamber α.

By mounting outer cylinder 31 to each wheel (wheel axle), and piston rod 36 to the vehicle body, variable-damping-force damper 3 is mounted to vehicle 1.

When piston rod 36 extends outward, piston 37 in inner cylinder 34 moves upward to pressurize the working fluid in upper cylinder chamber β. The pressurized working fluid in upper cylinder chamber β flows into voltage application path δ through communication hole 34a. At this time, the working fluid flows into lower cylinder chamber γ from reservoir chamber α through valve communication hole 33a, by an amount corresponding to the flow rate of the working fluid that has flowed into voltage application path δ.

When piston rod 36 retracts, piston 37 in inner cylinder 34 moves downward, and the working fluid in lower cylinder chamber γ flows into upper cylinder chamber β through communication hole 37a. At this time, piston rod 36 occupies a larger volume in inner cylinder 34 and thus, pushes out the working fluid so that this working fluid flows from upper cylinder chamber β into voltage application path δ through communication hole 34a. Then, the working fluid flows into lower cylinder chamber γ from reservoir chamber α through valve communication hole 33a, by an amount corresponding to the flow rate of the working fluid that has flowed into voltage application path δ.

When piston rod 36 either extends or retracts, the working fluid that has flowed into voltage application path δ through communication hole 34a moves in voltage application path δ toward communication hole 39a. At this time, the working fluid in voltage application path δ has a viscosity corresponding to a potential difference between inner cylinder 34 and electrode tube 38. This potential difference occurs through application of voltage thereto from high-voltage supply device 5 via conductive wires 71 and 72. With this configuration, the moving speed of the working fluid in voltage application path δ changes, to thereby obtain the damping force required of variable-damping-force damper 3.

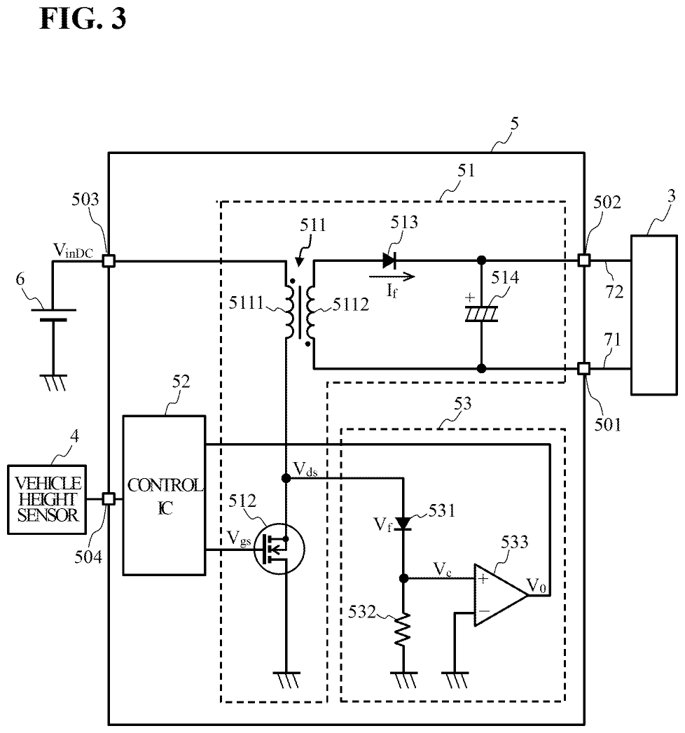

FIG. 3 shows an example of a high-voltage supply device in the vehicle damper system. High-voltage supply device 5 includes, as an externally excited flyback converter, a booster circuit 51 and a control integrated circuit (IC) 52. Booster circuit 51 performs boosting operation based on a control signal from control IC 52.

Booster circuit 51 is provided for each of four variable-damping-force dampers 3, so as to boost a power supply voltage of on-vehicle battery 6 as a DC power supply, and supply the thus-generated voltage to each variable-damping-force damper 3. Thus, high-voltage supply device 5 includes four booster circuits 51, but in FIG. 3, only one booster circuit 51, provided for a certain variable-damping-force damper 3, is illustrated for simplicity.

Booster circuit 51 includes a transformer 511, a first switching element 512, a first diode 513, and a smoothing capacitor 514. Booster circuit 51 is connected to on-vehicle battery 6 on its input side, and to variable-damping-force damper 3 on its output side.

Transformer 511 has such a form that an input-side primary coil 5111 and an output-side secondary coil 5112 are wound around a core (not shown). In FIG. 3, the solid circle denotes a polarity (winding start position) of each of primary coil 5111 and secondary coil 5112. Primary coil 5111 of transformer 511 has one end connected to a positive electrode of on-vehicle battery 6 via an input terminal 503, and has the other end connected to the body ground of vehicle 1 via first switching element 512 (finally connected to a negative electrode of on-vehicle battery 6; the same applies below). Secondary coil 5112 of transformer 511 has one end connected to conductive wire 72 via first diode 513 and output terminal 502, and has the other end connected to conductive wire 71 via output terminal 501.

First diode 513 has an anode connected to secondary coil 5112, and has a cathode connected to output terminal 502. With this configuration, first diode 513 has a rectification action of allowing current to flow in one direction from secondary coil 5112 to output terminal 502. Smoothing capacitor 514 is connected in parallel with secondary coil 5112 between two connection lines that connect secondary coil 5112 and output terminal 501, 502, so as to reduce pulsation of output voltage of booster circuit 51. More specifically, smoothing capacitor 514 has one terminal connected at some point of the connection line that connects secondary coil 5112 and output terminal 502, specifically, between the cathode of first diode 513 and output terminal 502.

First switching element 512 is a semiconductor switching element, which has a control terminal connected to control IC 52 and performs switching operation, specifically, is switched on or off based on a control signal input from control IC 52. During an ON state of first switching element 512, primary coil 5111 is electrically connected to the body ground of vehicle 1. During an OFF state of first switching element 512, primary coil 5111 is electrically disconnected from the body ground of vehicle 1.

In this example, a metal oxide semiconductor field effect transistor (MOSFET) is used as first switching element 512. A gate-source voltage V_{gs} at which first switching element 512 is turned on is defined as a gate threshold voltage Vₜₕ. First switching element 512 is not limited to the MOSFET, and it may be any semiconductor switching element that can perform switching operation based on a control signal input to its control terminal. For example, a bipolar transistor or an insulated gate bipolar transistor (IGBT) may be used instead.

Control IC 52 includes an internal microcomputer. Control IC 52 calculates a value (application voltage value) of a voltage to be applied to variable-damping-force damper 3 based on a vehicle height signal input from vehicle height sensor 4 via an input terminal 504, so as to adjust the level of the damping force of variable-damping-force damper 3. Control IC 52 performs switching control for switching first switching element 512 on or off based on the calculated application voltage value. Specifically, control IC 52 performs pulse width modulation (PWM) control to generate a PWM signal that causes first switching element 512 to perform switching operation. Then, control IC 52 outputs, to a gate terminal (control terminal) of first switching element 512, a gate drive signal (control signal) derived from the PWM signal. An ON/OFF ratio (duty) in the switching operation of first switching element 512 is set based on the application voltage value. The PWM signal is generated by comparing a carrier signal having a predetermined frequency and a command signal that indicates a voltage level corresponding to the above duty. The resultant PWM signal is a rectangular-wave pulse signal having two potential levels: high potential and low potential. Hence, the gate drive signal is a rectangular-wave pulse signal having two potential levels: high potential at which gate-source voltage V_{gs} is the gate threshold voltage Vₜₕ or higher, and low potential at which gate-source voltage V_{gs} is lower than the gate threshold voltage Vₜₕ.

In the flyback converter of high-voltage supply device 5, when the PWM signal is at the high potential, the gate drive signal derived from the PWM signal is at the high potential at which its voltage is the gate threshold voltage Vₜₕ or higher, with the result that first switching element 512 is turned on. Then, a current flows through primary coil 5111. The change in magnetic flux of primary coil 5111 generates via the core an induced electromotive force in secondary coil 5112. However, secondary coil 5112 has a polarity opposite to primary coil 5111 and thus, an induced current of secondary coil 5112 is interrupted by secondary-side first diode 513. Instead, a discharge current flows to output terminal 502 from smoothing capacitor 514 that has been charged during the OFF state of first switching element 512. In addition, an excitation energy supplied to primary coil 5111 during the ON state of first switching element 512 is accumulated in transformer 511. In contrast, when the PWM signal output from control IC 52 is at the low potential, first switching element 512 is turned off based on the PWM signal. Then, an induced electromotive force is generated in secondary coil 5112 in an opposite direction and thus, the inducted current of secondary coil 5112 flows to output terminal 502 through secondary-side first diode 513. As a result, the excitation energy accumulated in transformer 511 is released to variable-damping-force damper 3 and in addition, smoothing capacitor 514 is charged.

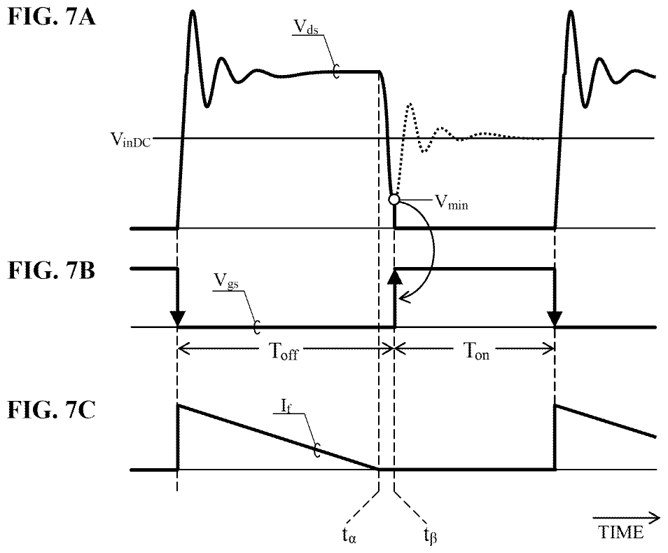

In this example, the flyback converter of high-voltage supply device 5 further includes an ON-timing detection circuit 53 for each booster circuit 51. ON-timing detection circuit 53 detects the timing to turn on first switching element 512. Now, referring to FIGS. 7A-7C, the reason for providing above ON-timing detection circuit 53 will be described, focusing on problems of a conventional flyback converter.

FIGS. 7A-7C are operating waveform charts of the conventional flyback converter. Although not shown, it is assumed that the conventional flyback converter has the same configuration as the externally excited flyback converter of high-voltage supply device 5 except ON-timing detection circuit 53. In the following, the same components are denoted by identical reference symbols.

FIG. 7A shows the change over time of a drain-source voltage V_{ds} of first switching element 512. FIG. 7B shows the change over time of the gate-source voltage V_{gs} of first switching element 512, that is, the gate drive signal. FIG. 7C shows the change over time of a forward current I_{f} of first diode 513.

In the conventional flyback converter, during the operation in a discontinuous current mode, when first switching element 512 is in an OFF period (T_{off}), and the forward current I_{f} becomes zero (time t_{α}), resonance (ringing) is induced. This resonance depends on the excitation inductance of transformer 511 and the parasitic capacitance of first switching element 512, for example. The resonance waveform is defined as change over time of the drain-source voltage V_{ds}, and it is indicated by the solid line from time t_{α} to time t_{β} and the dotted line from time t_{β}. Unless first switching element 512 is turned on, the oscillation of the drain-source voltage V_{ds} is gradually attenuated and dampened toward an input voltage V_{inDC}. Here, the externally excited flyback converter is considered to have the following risk. That is, assuming that first switching element 512 has a constant switching frequency, first switching element 512 can be turned on when the drain-source voltage V_{ds} is relatively high (for example, at a peak of the resonance waveform) under the resonance condition. In this case, the switching loss in first switching element 512 may considerably increase. To address the risk, some conventional externally excited flyback converters are designed to adjust the timing to turn on first switching element 512, so as to reduce the switching loss under the resonance condition. With this configuration, first switching element 512 can be turned on at the timing (time t_{β}) at which the drain-source voltage V_{ds} reaches a minimum value (valley) Vₘᵢₙ under the resonance condition.

However, when first switching element 512 is turned on at the timing (time t_{β}) at which the drain-source voltage V_{ds} reaches the minimum value Vₘᵢₙ, the drain-source voltage V_{ds} can be already lower than the input voltage V_{inDC}, and the energy accumulated in transformer 511 can be released and accordingly reduced. This leads to the deterioration of the boosting characteristic in a subsequent process.

In contrast, from the viewpoint of improving the boosting characteristic, it is preferred to turn on first switching element 512 at the timing (time t_{α}) at which the forward current I_{f} becomes zero, for example. At this timing, however, the drain-source voltage V_{ds} can be higher than the input voltage V_{inDC} and thus, the switching loss may increase.

In view of the above, ON-timing detection circuit 53 is provided in the flyback converter of high-voltage supply device 5 in order to identify an appropriate turn-on timing in consideration of the balance between the boosting and switching loss characteristics. In other words, ON-timing detection circuit 53 is provided in order to identify a turn-on timing at which either the boosting characteristic or the switching loss characteristic is not excessively deteriorated.

Referring back to FIG. 3, ON-timing detection circuit 53 includes a second diode 531, a resistor 532, and a comparator 533, in a path branched from some point between primary coil 5111 and first switching element 512. Second diode 531 has an anode connected between primary coil 5111 and a drain terminal of first switching element 512. Second diode 531 has a cathode connected to the body ground of vehicle 1 via resistor 532. Second diode 531 has a forward voltage drop V_{f} and thus, the cathode voltage of second diode 531 is level-shifted from the drain-source voltage V_{ds} by a given amount of voltage drop ΔV (=V_{f}).

Comparator 533 has a positive input terminal connected between the cathode of second diode 531 and resistor 532. Comparator 533 has a negative input terminal connected to the body ground of vehicle 1. Comparator 533 has an output terminal connected to control IC 52. Comparator 533 outputs the voltage at two potential levels: high potential and low potential, based on a result of comparing two comparator input voltages input to the positive input terminal and the negative input terminal. Here, the comparator may be a general-purpose operational amplifier.

In ON-timing detection circuit 53, the cathode voltage of second diode 531 is level-shifted from the drain-source voltage V_{ds} by the amount of voltage drop ΔV corresponding to the forward voltage drop V_{f} of second diode 531. Hence, a comparator input voltage V_{c} to be applied, as a comparison voltage, to the positive input terminal of comparator 533 is defined by (V_{ds}-V_{f}). When the comparator input voltage V_{c} is equal to the ground potential, comparator 533 outputs a comparator output voltage V₀ at the low potential to control IC 52. In contrast, when the comparator input voltage V_{c} is higher than the ground potential, comparator 533 outputs the comparator output voltage V₀ at the high potential to control IC 52.

Control IC 52 is configured as follows. That is, control IC 52 detects a falling edge of the comparator output voltage V₀ that is shifted from the high potential to the low potential. In response to the falling edge, control IC 52 outputs to the gate terminal of first switching element 512, a gate drive signal that turns on first switching element 512. Specifically, control IC 52 is configured to adjust the switching frequency of first switching element 512.

Control IC 52 can adjust the switching frequency as follows, for example. That is, control IC 52 detects a falling edge of the comparator output voltage V₀ by using a falling edge detection circuit such as a differentiation circuit. When detecting the falling edge of the comparator output voltage V₀, control IC 52 generates a sawtooth-wave carrier signal having a cycle between latest two falling edges as one cycle. Here, in the case of detecting the falling edge of the comparator output signal V₀ in the middle of one cycle of the carrier signal, control IC 52 generates a carrier signal for the next cycle at once in the above manner. Control IC 52 compares the thus-generated carrier signal with the command signal corresponding to the duty, to generate a PWM signal. The PWM signal generated by comparing the sawtooth-wave carrier signal and the command signal is at the high potential at the beginning of each carrier cycle, unlike a PWM signal generated by comparing a triangular-wave carrier signal and a command signal. Thus, the falling edge of the comparator output voltage V₀ can be substantially synchronized with the turn-on timing of first switching element 512. The next time control IC 52 detects the falling edge of the comparator output voltage V₀, control IC 52 generates a PWM signal in the above manner. Regarding the adjustment of the switching frequency in control IC 52, the adjustment may be partially or entirely made by the internal microcomputer executing software, unless PWM control is delayed.

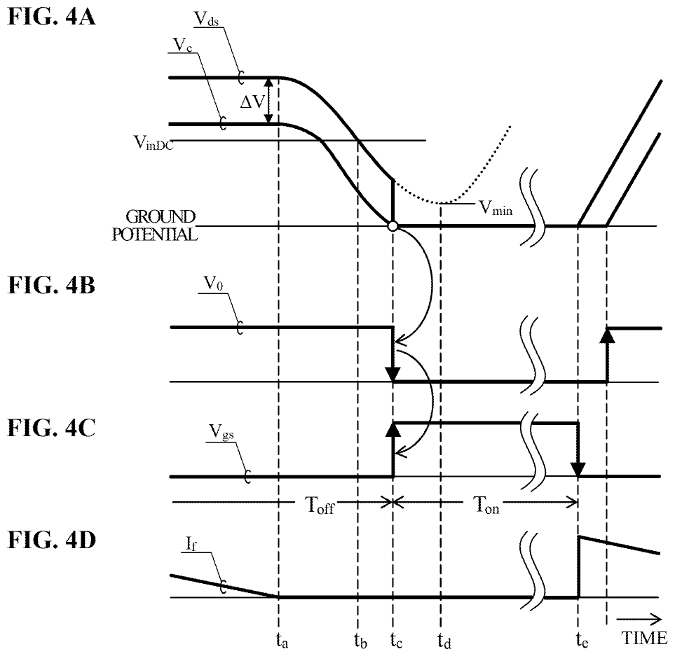

FIGS. 4A-4D are operating waveform charts of the flyback converter in the high-voltage supply device. It should be noted that the operating waveform charts of FIGS. 4A-4D are focused on the resonance that is induced during the operation in a non-continuous mode when first switching element 512 is in an OFF period (T_{off}), and the forward current I_{f} becomes zero. Hence, the time axis is extended more than the operating waveform charts of FIGS. 7A-7C.

FIG. 4A shows the changes over time of the drain-source voltage V_{ds} of first switching element 512 and the comparator input voltage V_{c}. FIG. 4B shows the change over time of the comparator output voltage V₀. FIG. 4C shows the change over time of the gate-source voltage V_{gs} of first switching element 512, that is, the gate drive signal. FIG. 4D shows the change over time of the forward current I_{f} of first diode 513.

When the forward current I_{f} of first diode 513 becomes zero at time t_{α}, the drain-source voltage V_{ds} of first switching element 512 starts to reduce due to resonance. The comparator input voltage V_{c} is a voltage level-shifted by second diode 531 from the drain-source voltage V_{ds} by the amount of voltage drop ΔV. The comparator input voltage V_{c} starts to reduce along with the drain-source voltage V_{ds}. At this time, the comparator input voltage V_{c} is higher than the ground potential and thus, the comparator output voltage V₀ is held at the high potential. Moreover, the flyback converter of high-voltage supply device 5 operates in the non-continuous mode and thus, the gate-source voltage V_{gs} (gate drive signal) of first switching element 512 is also held at the low potential.

When the amount of voltage drop ΔV is set as below, the comparator input voltage V_{c} is reduced to the ground potential at time t_{c} between time t_{b} at which the drain-source voltage V_{ds} of first switching element 512 is reduced to the input voltage V_{inDC} and time to at which the drain-source voltage V_{ds} reaches the minimum value Vₘᵢₙ under the resonance condition. As a result, the comparator output voltage V₀ is shifted from the high potential to the low potential.

When detecting the falling edge of the comparator output voltage V₀, control IC 52 shifts the PWM signal from the low potential to the high potential in response to the falling edge. Then, the gate-source voltage V_{gs} (gate drive signal) is shifted from the low potential to the high potential. With this operation, first switching element 512 is turned on at the drain-source voltage V_{ds} between the input voltage V_{inDC} and the minimum value Vₘᵢₙ.

After that, at time tₑ, the gate-source voltage V_{gs} (gate drive signal) is shifted to the low potential in response to the falling edge of the PWM signal. Then, first switching element 512 is turned off, and the drain-source voltage V_{ds} is increased again. In addition, the excitation energy accumulated during the ON state of first switching element 512 is released and thus, the forward current I_{f} of first diode 513 is rapidly increased. After that, the comparator input voltage V_{c} exceeds the ground potential again and thus, the comparator output voltage V₀ is shifted from the low potential to the high potential. It should be noted that control IC 52 is not designed to shift the PWM signal or the gate drive signal from the high potential to the low potential in response to a rising edge of the comparator output voltage V₀.

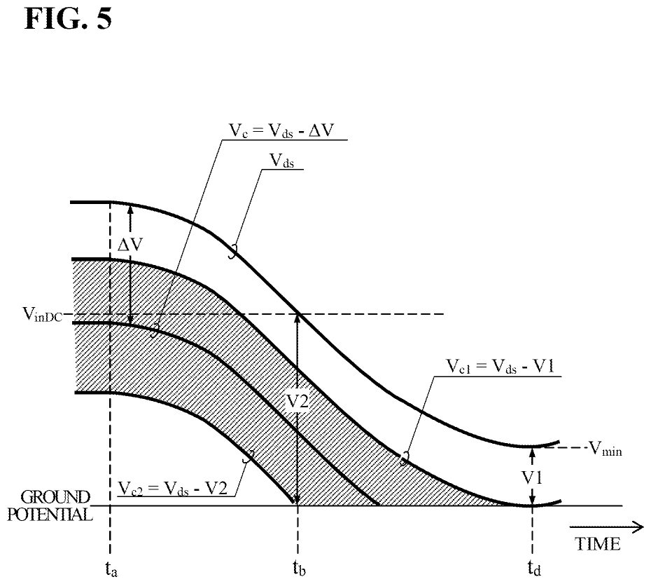

FIG. 5 is a graph showing how to set the amount of voltage drop in level-shifting from the drain-source voltage to generate a comparator input voltage. FIG. 5 shows an appropriate range (hatched portion) of the comparator input voltage V_{c} with respect to the drain-source voltage V_{ds} in the above duration from time tₐ to time t_{d} (see FIGS. 4A-4D). As described above, the flyback converter of high-voltage supply device 5 is intended to turn on first switching element 512 at an appropriate timing in consideration of the balance between the boosting and switching loss characteristics. To that end, the amount of voltage drop ΔV by which to level-shift the drain-source voltage V_{ds} to generate the comparator input voltage V_{c} is set as follows. That is, the amount of voltage drop ΔV is set such that the comparator input voltage V_{c} reaches the ground potential at between time t_{b} at which the drain-source voltage V_{ds} of first switching element 512 is reduced to the input voltage V_{inDC} and time to at which the drain-source voltage V_{ds} reaches the minimum value Vₘᵢₙ, under the resonance condition. Specifically, if the comparator input voltage V_{c} (V_{c1}) is reduced to the ground potential when the drain-source voltage V_{ds} of first switching element 512 reaches the minimum value Vₘᵢₙ under the resonance condition, the amount of voltage drop ΔV thereof is the lower limit V1. If the comparator input voltage V_{c} (V_{c2}) is reduced to the ground potential when the drain-source voltage V_{ds} of first switching element 512 is reduced to the input voltage V_{inDC}, the amount of voltage drop ΔV thereof is the upper limit V2. Accordingly, the amount of voltage drop ΔV (=V_{f}) in level shifting by second diode 531 is set as appropriate within the range larger than the lower limit V1 and smaller than the upper limit V2 (V1<ΔV<V2). In other words, second diode 531 is selected to have forward voltage drop V_{f} satisfying the relationship V1<V_{f}<V2.

Here, how the drain-source voltage V_{ds} changes over time varies depending on a circuit condition of the flyback converter. Hence, the lower limit V1 and the upper limit V2 of the amount of voltage drop ΔV are set in consideration of various changes in circuit condition expected from simulation or experiment, for example. The changes in circuit condition include variations of the input voltage V_{inDC} resulting from the power supply voltage change of on-vehicle battery 6 and variations of an application voltage value resulting from the change in damping force required of variable-damping-force damper 3. For example, the minimum value Vₘᵢₙ of the drain-source voltage V_{ds} under the resonance condition varies depending on the circuit condition. Hence, if the comparator input voltage V_{c} (V_{c1}) is reduced to the ground potential when the drain-source voltage V_{ds} of first switching element 512 reaches the minimum value Vₘᵢₙ that is the largest in the variation range, the lower limit V1 is set to the amount of voltage drop ΔV thereof. In addition, the upper limit V2 corresponds to the input voltage V_{inDC} regardless of the variations of the drain-source voltage V_{ds} resulting from the change in circuit condition. However, the input voltage V_{inDC} varies depending on the power supply voltage change of on-vehicle battery 6, and thus, the upper limit V2 is set to the minimum value in the variation range of the input voltage V_{inDC}.

Here, first switching element 512 may be alternatively turned on when the drain-source voltage V_{ds} reaches a predetermined voltage Vx between the input voltage V_{inDC} and the minimum value Vₘᵢₙ, without using the comparator input voltage V_{c} that is level-shifted from the drain-source voltage V_{ds}. In this case, the comparator requires a reference voltage generator circuit so as to generate, as a reference voltage, the predetermined voltage Vx to be compared with the drain-source voltage V_{ds}. However, assuming that the reference voltage generator circuit has low output stability, there is a risk that first switching element 512 cannot be turned on at the drain-source voltage V_{ds} between the input voltage V_{inDC} and the minimum value Vₘᵢₙ, in consideration of the variations of the input voltage V_{inDc} and the minimum value Vₘᵢₙ. In the case of suppressing influence of the temperature dependence or power supply voltage change of on-vehicle battery 6, for example, so as to improve the output stability of the reference voltage generator circuit, the circuit configuration is complicated, and mounting area and product cost increase. In contrast, the flyback converter of high-voltage supply device 5 compares the ground potential and the comparator input voltage V_{c} that is level-shifted from the drain-source voltage V_{ds} by the amount of voltage drop ΔV. This is advantageous in that no reference voltage generator circuit having high stability is required.

According to the above flyback converter of high-voltage supply device 5, first switching element 512 can be turned on at an appropriate timing in consideration of the balance between the boosting and switching loss characteristics, with relatively simple configuration.

### Embodiment 2

Next, a load driving device according to Embodiment 2 of the present invention is described. In Embodiment 2, it is assumed that the load driving device is a high-voltage supply device adopted in a vehicle damper system as in Embodiment 1. The same components as Embodiment 1 are denoted by identical reference symbols, and thus are not described or are described briefly.

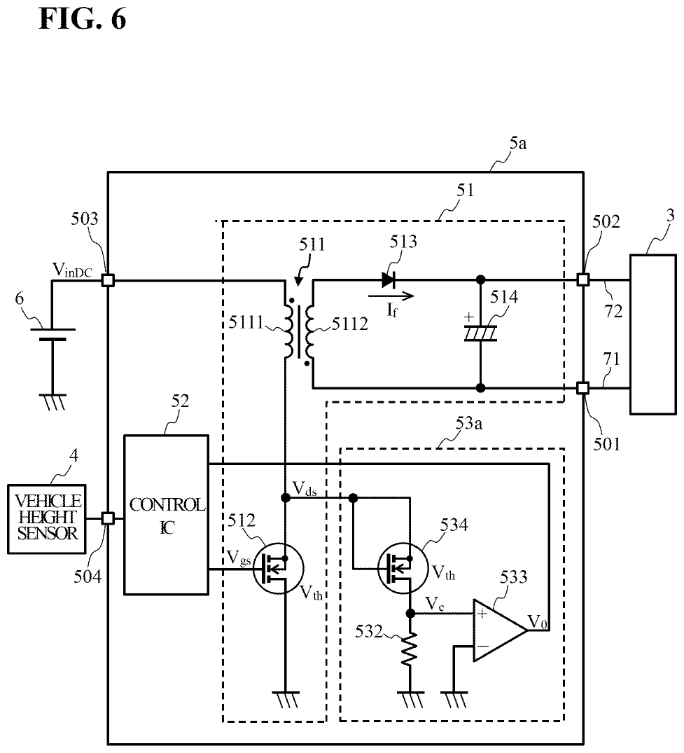

FIG. 6 shows an example of the high-voltage supply device in the vehicle damper system. A high-voltage supply device 5a of the vehicle damper system includes, as the flyback converter, booster circuit 51, control IC 52, and an ON-timing detection circuit 53a.

ON-timing detection circuit 53a includes a second switching element 534 in place of second diode 531. Second switching element 534 is an N-channel MOSFET having a gate threshold voltage Vₜₕ, and has the same voltage drop characteristic and temperature dependence as first switching element 512. Second switching element 534 has a drain terminal and a gate terminal connected between primary coil 5111 and the drain terminal of first switching element 512. Second switching element 534 has a source terminal connected to the body ground of vehicle 1 via resistor 532. Comparator 533 has the positive input terminal connected between a source terminal of second switching element 534 and resistor 532.

Second switching element 534 is a diode-connected MOS having short-circuited drain terminal and gate terminal. Second switching element 534 functions as a diode having a forward voltage drop corresponding to the gate threshold voltage Vₜₕ. Hence, in the ON state of second switching element 534, a source voltage of second switching element 534 is level-shifted from the drain-source voltage V_{ds} of first switching element 512 by a given amount of voltage drop ΔV (=Vₜₕ). The amount of voltage drop ΔV (=Vₜₕ) in level-shifting by second switching element 534 is set as appropriate within the above range (V1<ΔV<V2). Specifically, second switching element 534 is selected to have the gate threshold voltage Vₜₕ satisfying the relationship V1<Vₜₕ<V2.

Comparator 533 outputs the comparator output voltage V₀ at the low potential to control IC 52 when the comparator input voltage V_{c} (=V_{ds}-Vₜₕ) is equal to the ground potential. Conversely, comparator 533 outputs the comparator output voltage V₀ at the high potential to control IC 52 when the comparator input voltage V_{c} is higher than the ground potential. Control IC 52 detects the falling edge of the comparator output voltage V₀. Then, in response to the falling edge, control IC 52 outputs, to the gate terminal of first switching element 512, a gate drive signal that turns on first switching element 512. With this operation, first switching element 512 is turned on at the drain-source voltage V_{ds} between the input voltage V_{inDC} and the minimum value Vₘᵢₙ.

According to the above flyback converter of high-voltage supply device 5a, first switching element 512 can be turned on at an appropriate timing in consideration of the balance between the boosting and switching loss characteristics, with relatively simple configuration as in Embodiment 1.

Moreover, the flyback converter of high-voltage supply device 5a adopts, as an element that causes voltage drop in ON-timing detection circuit 53a, second switching element 534 having equivalent voltage drop characteristic and in turn, equivalent temperature dependence to first switching element 512. Hence, even when the drain-source voltage V_{ds} changes depending on the circuit condition and ambient temperature, second switching element 534 can level-shift the voltage by the amount of voltage drop ΔV corresponding to the degree of the above change. Accordingly, the influence of the changes in circuit condition and ambient temperature can be suppressed, to thereby more easily turn on the switching element at an appropriate timing in consideration of the balance between the boosting and switching loss characteristics.

In Embodiments 1 and 2 above, when the drain-source voltage V_{ds} is reduced to the ground potential through resonance, the amount of voltage drop ΔV is set as follows. That is, the amount of voltage drop ΔV is set such that the comparator input voltage V_{c} reaches the ground potential at between time t_{b} at which the drain-source voltage V_{ds} of first switching element 512 is reduced to the input voltage V_{inDC} and the time at which the drain-source voltage V_{ds} reaches the ground potential.

In Embodiments 1 and 2 above, for example, the following is conceivable: a ground potential is lower at a ground point to which the positive input terminal of comparator 533 is connected via resistor 532 than at a ground point to which the negative input terminal of comparator 533 is connected. In this case, when the amount of voltage drop ΔV is set such that the comparator input voltage V_{c} reaches the ground potential at around time t_{d} (see FIG. 5) at which the drain-source voltage V_{ds} reaches the minimum value Vₘᵢₙ, the comparator input voltage V_{c} of the positive input terminal may not be reduced to the ground potential of the negative input terminal. To address this risk, comparator 533 can be selected to have the following input offset voltage. That is, it is possible to select, as comparator 533, a comparator in which when the comparator output voltage V₀ is at the low potential, the input voltage of the negative input terminal is higher than the input voltage of the positive input terminal. With this configuration, the ground potential of the negative input terminal is offset to a positive side. Hence, even when the comparator input voltage V_{c} of the positive input terminal is not reduced to the ground potential of the negative input terminal, the comparator output voltage V₀ can be shifted from the high potential to the low potential.

Embodiments 1 and 2 above are described on the assumption that ON-timing detection circuit 53, 53a is provided outside control IC 52. However, the present invention is not limited thereto, and control IC 52 may incorporate therein a part of, or all of, ON-timing detection circuit 53, 53a.

In Embodiment 2 above, second switching element 534 is not limited to the N-channel MOSFET, and it can be any element that is diode-connected to thereby have voltage drop corresponding to the forward voltage drop, such as an NPN transistor having short-circuited collector and base.

In Embodiment 2 above, first switching element 512 and second switching element 534 are assumed to have the same voltage drop characteristic, that is, the same gate threshold voltage. However, according to another embodiment, first switching element 512 and second switching element 534 may be different in voltage drop characteristic, that is, in gate threshold voltage. This configuration also produces the same effects as the flyback converter of Embodiment 1 that adopts second diode 531.

The load driving device is only required to drive a load with an output of the flyback converter, and is not limited to high-voltage supply device 5 that supplies a voltage to be applied to the variable-damping-force damper. For example, the load may be a fuel injection valve, and the load driving device may be a fuel injection control device including a flyback converter that supplies a drive voltage thereto.

The above description is made for the invention completed by the inventor of the present invention based on Embodiments 1 and 2 above. However, the present invention is not limited to the above embodiments and, needless to say, encompasses various modifications without departing from the gist of the present invention. Furthermore, technical features described independently in Embodiments 1 and 2 above can be combined as appropriate unless being technically inconsistent.

### REFERENCE SYMBOL LIST

3 Variable-damping-force damper
5, 5a High-voltage supply device
6 On-vehicle battery
51 Booster circuit
52 Control IC
53, 53a ON-timing detection circuit
511 Transformer
512 First switching element
531 Second diode
533 Comparator
534 Second switching element
5111 Primary coil
5112 Secondary coil
V_{ds} Drain-source voltage
V_{c} Comparator input voltage
V₀ Comparator output voltage
ΔV Voltage drop
V_{gs} Gate-source voltage
Vₜₕ Gate threshold voltage
V_{f} Forward voltage drop

1. A load driving device comprising a flyback converter, the flyback converter including:
a transformer including a primary coil to be connected to a power supply and a secondary coil to be connected to a load; and
a switching element provided on a ground side of the primary coil, which controls a voltage to be applied to the primary coil, wherein
the load driving device is configured to generate a comparison voltage which is lower than a voltage between the primary coil and the switching element, and to switch the switching element from an OFF state to an ON state when the comparison voltage is reduced to a predetermined voltage, and
the comparison voltage is generated by a diode that reduces the voltage between the primary coil and the switching element by a predetermined amount of voltage drop.

2. (canceled)

3. The load driving device according to claim 1, wherein the diode is provided in a path branched from a point between the primary coil and the switching element.

4. A load driving device comprising a flyback converter, the flyback converter including:
a transformer including a primary coil to be connected to a power supply and a secondary coil to be connected to a load; and
a switching element provided on a ground side of the primary coil, which controls a voltage to be applied to the primary coil, wherein:
the load driving device is configured to generate a comparison voltage which is lower than a voltage between the primary coil and the switching element, and to switch the switching element from an OFF state to an ON state when the comparison voltage is reduced to a predetermined voltage, and
the comparison voltage is generated by a diode-connected voltage drop element that reduces the voltage between the primary coil and the switching element by a predetermined amount of voltage drop.

5. The load driving device according to claim 4, wherein the voltage drop element is provided in a path branched from a point between the primary coil and the switching element.

6. The load driving device according to claim 4, wherein the voltage drop element has the same characteristics as the switching element.

7. The load driving device according to claim 1, wherein the predetermined voltage is at a ground potential.

8. The load driving device according to claim 4, wherein the predetermined voltage is at a ground potential.

9. The load driving device according to claim 4, wherein the voltage drop element is a switching element that functions as a diode.
